(19) United States
(12) Patent Application Publication
(10) Pub. No.: US 2017/0196237 A1
(43) Pub. Date: Jul. 13, 2017

(54) MATERIAL AND FREEZE CASTING AND IMPREGNATION METHOD OF CARBOHYDRATE SCAFFOLDS

(71) Applicant: The Trustees of Dartmouth College, Hanover, NH (US)

(72) Inventor: Ulrike G.K. WEGST, Hanover, NH (US)

(21) Appl. No.: 15/313,045

(22) PCT Filed: May 21, 2015
(86) PCT No.: PCT/US15/32027

§ 371 Date: Nov. 21, 2016

Related U.S. Application Data
(60) Provisional application No. 62/001,526, filed on May 21, 2014.

(51) Int. Cl. A23G 1/54; A23P 30/10; A23P 20/10; A23B 7/024; A23L 19/00

(52) U.S. Cl. CPC A23G 1/54; A23B 7/024; A23L 19/09; A23P 20/11; A23P 30/10; A23V 2002/00

(57) ABSTRACT

An edible includes a directionally porous mass of at least one carbohydrate with a low-moisture infiltrate disposed within pores comprising at least one fat selected from melted chocolate, butter, cocoa butter, coconut oil, palm oil, or cream. The edible is prepared by directionally freeze-casting an aqueous solution or slurry including a carbohydrate; freezing the solution or slurry with directional crystal growth by applying low temperatures with a temperature gradient to the solution or slurry, and lyophilizing the frozen slurry. In embodiments, the solution or slurry includes fruit juice or puree, or finely ground vegetable matter such as cocoa powder or peanut butter powder.

### RELATED APPLICATIONS

The present application claims priority to U.S. Provisional Patent Application 62/001,526 filed 21 May 2014, the entire contents of which are incorporated herein by reference.

### GOVERNMENT INTEREST

The invention was made with government support under grant 1200408 awarded by the Civil, Mechanical and Manufacturing Innovation (CMMI) Division of the National Science Foundation. The government has certain rights in the invention.

### FIELD

The present document relates to the field of directionally-freeze cast, lyophilized, and impregnated candies and foods.

### BACKGROUND

Ingredients

The prime constituents of milk chocolate or dark chocolate are sugar, cocoa butter, cocoa solids (frequently added in the form of cocoa liquor—a blend of cocoa butter and cocoa solids), sugar, and dried or concentrated milk in various concentrations, cheaper versions may include one or more lower-cost fats in place of part or all of the cocoa butter. White chocolate typically includes sugar, dried or concentrated milk, and cocoa butter in various concentrations; again cheaper versions may also include a lower-cost fat in place of part of the cocoa butter. In both milk, dark and white chocolate, flavorings such as vanilla and other additives such as lecithin as emulsifier are frequently added. In traditional chocolate and chocolate products, cocoa butter and/or lower cost cocoa butter equivalent fats are added to cocoa liquor and mixed with other ingredients such as sugar, milk (in the form of powder or concentrate), emulsifiers and flavorings. The resulting melted chocolate is typically worked and heat treated (tempered) at well defined temperatures specific to each composition to ensure formation of desirable cocoa-butter crystal forms, and then typically cast and allowed to solidify. The thermal history and crystal forms determine, for example, the optical appearance and snappiness of the “snap” upon fracture. In addition to chocolate bars, which may also be porous, chocolate is frequently melted for it to be cast over or around a filling or coated onto ice cream, strawberries, or other edible inclusions.

Sugars are short-chain carbohydrates, typically with only one or a few saccharide monomers, including monosaccharides, disaccharides, and oligosaccharides. Simple sugars, or monosaccharides, include, for example, glucose (dextrose), fructose and galactose. Monosaccharides are the building blocks of disaccharides; to this group belong sugars such as sucrose (composed of covalently bonded glucose and fructose), lactose (glucose and galactose), maltose (diglucose) and trehalose (diglucose). Chemically similar to monosaccharides are the sugar alcohols, such as mannitol and sorbitol, which are often used as less nutritive sweeteners; for purposes of this document the term monosaccharide includes sugar alcohols. Oligosaccharides are composed of a few (typically three to nine) monosaccharides. Polysaccharides, typically not referred to as sugars but constructed from them, including starch, pectin, cellulose and chitin, are composed of long chains of monosaccharide units.

Disaccharides, oligosaccharides, and polysaccharides may be found in foods in intact form, and are often added to foods as thickening agents, or may be hydrolyzed into their component sugars. Examples of hydrolyzed polysaccharides commonly found in foods include corn syrup, high fructose corn syrup, and invert sugar. Invert or inverted sugar is a mixture of the monosaccharides fructose and glucose; invert sugar is obtained when sucrose is hydrolyzed into its two constituents. Invert sugar is sweeter than sucrose and is valued in candy making because it tends to retain moisture.

Honey produced by honeybees, is primarily composed of fructose and glucose, and, depending on the flower nectars that are used to make it, may also contain maltose, sucrose, and other complex carbohydrates. Some properties of honey resemble those of invert sugar.

Maple sap is traditionally collected in springtime from the xylem of sugar maple or various other species of maple trees; also some other species such as birch trees can be tapped to collect sap that is high in sugar content. Maple sap consists primarily of sucrose and water. Maple syrup is made from maple sap by dehydrating maple sap. It additionally contains small amounts of the monosaccharides glucose and fructose from invert sugar formed in the boiling process as well as other flavoring compounds.

Sugars are frequently ingredients in food, candy and confectionery. They are used and consumed in crystalline or glassy form, or when dissolved in a solvent such as water.

Chocolate is derived from fermented cacao beans, these beans are ground and fat, known as cocoa butter, is removed. The remaining solid portions are ground to form cocoa powder, a low-fat, finely ground, vegetable matter. Other seeds, including coconuts, walnuts, pecans, almonds, hazelnuts, and peanuts, can also be ground and fat removed to produce a finely ground, low-fat, vegetable matter. In some cases, finely ground vegetable matter may work even without removal of fat.

Chocolate may be cast around freeze-dried inclusions, such as freeze-dried strawberries or blueberries, however the pore structure of typical freeze-dried fruit is, in contrast to the materials described herein, may not be amenable to infiltrating (or impregnating) the fruit with the chocolate.

### Freeze Casting

In freeze casting, as described by Heschel et al. in U.S. Pat. No. 6,447,701 and in our granted U.S. Pat. No. 8,877,498, an aqueous solution or slurry is prepared; a slurry may include water, or solutes with water in a solution, with additional particulate ingredients suspended in the water or solution. The solution or slurry is cooled to a sufficiently low temperature that ice crystals form within it. Since solutes and suspended particles tend not to be included in the forming ice crystals, these solutes and particles become concentrated between crystals where they form a composite, thereby ice-templating a 3D microstructure and architecture and producing a material with a self-assembled, hierarchical pore structure. Once frozen ice crystals are removed by lyophilization or freeze-drying.

### SUMMARY

An edible includes a directionally porous mass of at least one carbohydrate with a non-aqueous or a low-to-medium-moisture content infiltrate disposed within pores comprising at least one fat selected from melted chocolate, cocoa butter, butter, palm oil, coconut oil, or dairy cream. The edible is prepared by directionally freeze casting an aqueous solution or slurry including a carbohydrate; freezing the solution or slurry with directional crystal growth by applying low temperatures with a temperature gradient to the solution or slurry, and lyophilizing the frozen slurry. In embodiments, the solution or slurry includes fruit juice or puree, or finely ground vegetable matter such as almond flour, cocoa powder or peanut butter powder.

In an embodiment, an edible includes a directionally or partially-directionally porous mass of at least one carbohydrate with a low-moisture infiltrate disposed within pores comprising at least one fat selected from melted chocolate, butter, cocoa butter, coconut oil, palm oil, or cream.

In an embodiment, an edible is prepared by directionally freeze casting an aqueous solution or slurry including at least one carbohydrate; freezing the solution or slurry with directional crystal growth by applying low temperatures with a temperature gradient to the solution or slurry, and lyophilizing the frozen slurry to form a casting. In embodiments, the solution or slurry includes fruit juice or puree, or finely ground vegetable matter such as almond powder, cocoa powder or peanut butter powder. In embodiments, after lyophilization, the casting is impregnated with an infiltrate including melted chocolate, butter, cocoa butter, coconut oil, palm oil, or cream. The casting or infiltrate may contain water-soluble, oil-soluble or alcohol-based flavorings.

### BRIEF DESCRIPTION OF THE DRAWINGS

FIG. 1 is a schematic diagram of a directional freeze-caster.

FIG. 2 is a schematic diagram of an alternative freeze-caster.

FIG. 2A is a schematic cross sectional diagram of another alternative freeze-caster.

FIG. 3 is a flowchart of a method of producing a sugar-and-cocoa based casting impregnated with a fatty and or low-to-medium-moisture phase, such as cocoa butter or low moisture chocolate.

FIG. 4 is a micrograph of a section of a high-porosity casting prepared by directional freeze-casting and lyophilization.

### DETAILED DESCRIPTION OF THE EMBODIMENTS

Directional Freeze-Casting

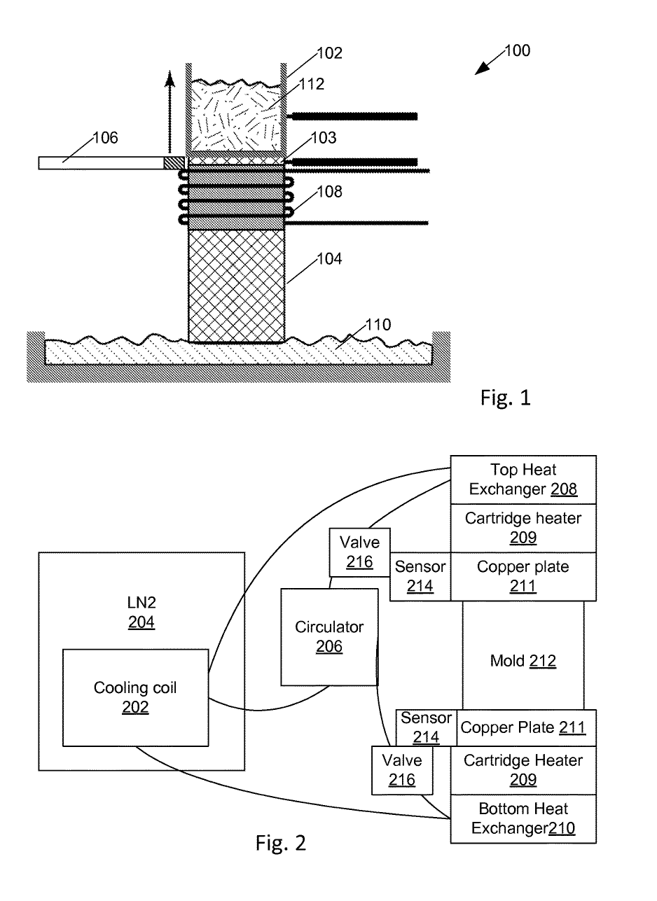

When freezing or freeze casting an aqueous solution or slurry, a temperature gradient may be applied to the solution or slurry and its mold, portions of slurry held at lower temperatures will tend to freeze more quickly than other portions, and ice crystals nucleated in these colder zones will grow along the thermal gradient into other zones as those other zones cool to below the freezing point of the slurry. In FIG. 33 of our issued U.S. Pat. No. 8,877,498 (Nov. 4, 2014), we describe a directional freeze-caster 100 also described with reference to FIG. 1 herein.

The mold, as illustrated in FIG. 1, is a Teflon tube 102 placed on a cooled plate 103 that closes the tube and is attached to a copper cold finger 104 with a top end adjacent to the bottom end of the tube. The cold finger 104 top end is temperature regulated by using feedback from a thermocouple 106 attached to the cooled plate applied to an electric heater 108 attached to the finger. The cold finger is cooled by immersing its lower end into liquid nitrogen 110. A seal is formed around the edge of the copper base plate between the edge of the base plate and the bottom of the mold, in an embodiment a Teflon seal is provided or in some embodiments an edible grease or fatty substance such as cocoa butter or palm oil is applied to these surfaces to prevent leakage. The mold in some embodiments is round, square or rectangular, in other embodiments the mold has a heart-shape, Christmas-tree shape, or other complex shape; the shape of the mold helps determine the shape of the casting.

The copper base plate 103 is then placed on top of the copper rod, or “cold finger,” which stretches down into a liquid nitrogen bath 110. The temperature at the top of the copper rod is monitored by a thermocouple 106 and temperature clines are regulated via a PID controller and a powerful heating element 108 near the top of the cold finger. In embodiments, the determined cooling rate is either 1 or 10° C. min-1, and cooling continues typically from 5° C. to a minimum temperature of −150° C. The determined cooling rate helps control a rate of ice-crystal growth in the sample, and thus control freeze-front progression as freezing progresses. As freezing progresses of slurry 112 in the freeze-casting mold 102, an ice phase (not shown) nucleates at the cold plate, and grows along the thermal gradient (here upwards) through the mold, concentrating solute and particles between the crystals thereby ice-templating it, thus forming a material. The material includes solutes and solids from the solution or slurry and has a hierarchical architecture whose pores are filled with ice. In a particular embodiment, each mold has a tubular shape with an inner diameter of 18.8 mm (¾ inch) and a height of 40 mm. Typical directionally freeze-cast materials have pore diameters between 10 and 300 microns measured perpendicular to the applied thermal gradient, but larger and smaller ones can be generated with selected freezing conditions; parallel to the applied thermal gradient, these pores may be as long as an entire casting.

When castings are fully frozen, they are removed from the cold finger, the samples are punched out of the mold using an Arbor press. The green casting is then freeze-dried for 48-72 h in a FreeZone 4.5 Liter Benchtop Freeze Dry System (Labconco, Kansas City, Mo.) to remove the ice phase.

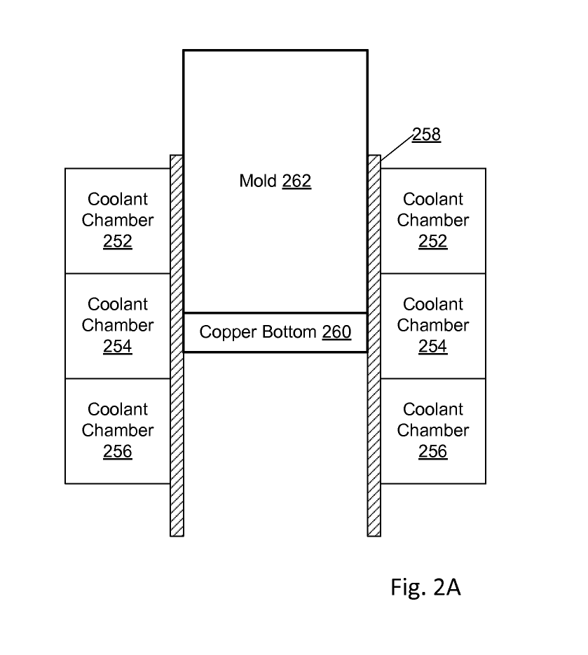

In another embodiment of a directional freeze-caster, as illustrated in FIG. 2, a cooling coil 202 is placed in a liquid nitrogen coolant reservoir 204. Coolant, in an embodiment low pressure dry nitrogen, or another dry gas that remains liquid at liquid nitrogen temperatures, is circulated by a circulator pump 206 through an upper 208 and a lower 210 heat exchanger, each heat exchanger is attached to cartridge heater 209 and a copper plate 211 in contact with a mold 212. In this embodiment, chilling of the heat exchangers 208, 210, forms a temperature gradient and ice crystals nucleate at the copper plates and grow inwards into slurry in the mold 212. Each copper plate 211 is fitted with a temperature sensor 214. A controller, not shown, uses readings from temperature sensors 214 to control coolant valves 216 and cartridge heaters 209 to ensure temperatures of the copper plates follow a predetermined temperature program during directional freeze casting.

In yet another alternative embodiment, one, two, three, or more separate coolant chambers 252, 254, 256 are formed around a central copper tube 258. Coolant, which in some embodiments is an ethylene glycol-antifreeze blend, chilled to appropriate temperatures by chilling devices (not shown) is placed in the coolant chambers. In an embodiment, the glycol-antifreeze blend is chilled to −40° C. A mold assembly including a copper mold bottom plate 260 and a mold 262, containing solution or slurry, is lowered into and slid through copper tube 258 at a rate determined to advance the freezing front within the solution or slurry at an appropriate rate.

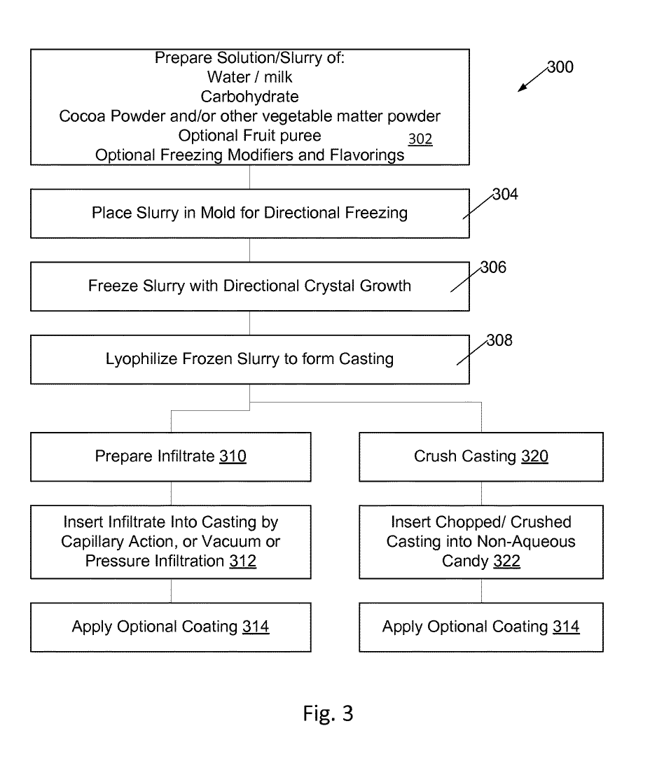

A directionally- partially-directionally-, or if conditions are off a non-directionally-porous material is formed by a method 300 (FIG. 3) that begins with preparing 302 a carbohydrate solution or slurry including carbohydrate solution with optional suspended cocoa solids or other finely-ground edible vegetable matter such as peanut butter powder, coconut powder, hazelnut powder, walnut powder, pecan nut powder or almond powder. The slurry or solution may also include flavoring additives such as vanilla extract or malic acid, and/or freeze modifiers. In some embodiments, a fine-ground fruit puree with or without added sugars such as applesauce is incorporated into the slurry. In some embodiments, the slurry or solution includes one or more fruit juices or fruit juice concentrates, such as grape, pomegranate, or blackberry juice as a source of both flavoring and some or all of the carbohydrates; experiments have been successfully performed using commercial fruit jellies that include such juices or juice concentrates typically combined with additional carbohydrates such as pectin and sugars. A freeze modifier that may be used in some recipes and is removable during freeze-drying is ethyl alcohol (ethanol), presence of ethanol during directional freeze-casting is known to produce pores of greater diameter than those frozen without ethanol. Protein-based binders, such as gelatin, may also be added.

The carbohydrate solution is prepared by dissolving carbohydrate in water, or diluting liquid carbohydrate sources such as syrups with water, according to a particular recipe and contains edible carbohydrate such as a carbohydrate selected from one or more of sucrose, fructose, glucose, maltose, invert sugar, lactose, trehalose, maple sap, maple syrup or maple sugar, honey, corn syrup, methyl cellulose, sorbitol, mannitol, or mannose. The solution or slurry may in some embodiments contain carbohydrate thickening agents such as starch, pectin, or alginates; and in some embodiment protein-based thickening agents such as gelatin. Milk or milk products such as milk powder or sweetened condensed milk, may be used in the carbohydrate solution as a source of both carbohydrate and water. Flavor additives may include peppermint extract, vanilla extract, or similar flavoring solutions miscible with, or soluble in, water. It is noted that the processing described herein involves low temperatures so that volatile and heat-labile flavorings are retained in the product, and that the carbohydrates used in the solution may include both sweeteners and thickeners.

Prepared solution or slurry is placed 304 in a mold 102, 212 of the directional freeze-caster, and the solution or slurry is frozen 306 allowing directional crystal growth as heretofore described by using the freeze-caster to apply low temperatures with a temperature gradient to the solution or slurry. The frozen slurry is then lyophilized 308 to remove the ice crystals, leaving a directionally-porous scaffold or casting.

Once frozen and dried, castings containing sucrose, maple sap, maple syrup, maple sugar or other hydroscopic sugars are placed in a glass desiccation chamber with silica gel desiccant (−3+8 mesh granules, Alfa Aesar, Ward Hill, Mass.) with relative humidity 0.0 in order to keep atmospheric moisture from hydrating the sugar until such a time as they could be subjected to further processing such as infiltration, crushing, or consumption.

A non-aqueous or low-to-medium moisture infiltrate is prepared 310, typically based on an edible fat or oil. In an embodiment this infiltrate is a prepared milk, dark or white chocolate, in another embodiment it is cocoa butter, in another embodiment it is a fruit jelly; flavor and color additives may optionally be included. In alternative embodiments, other infiltrates based on flavored and/or sugared oils, such as butter, cream, coconut or palm oil are used. The infiltrate is melted by heating, with chocolate or cocoa butter infiltrates it is heated to a temperature above the melting point of the respective chocolate or cocoa butter. With castings based on a solution or slurry primarily containing short-chain carbohydrates or sugars, such as sucrose, fructose, or glucose, the infiltrate should be non-aqueous or have a sufficiently low moisture content so that it does not compromise the structure of the casting by dissolving the casting. Castings containing significant amounts of longer-chain carbohydrates that dissolve less rapidly, or protein gelling agents like gelatin, can tolerate a greater water content in the infiltrate.

The infiltrate is inserted 312 into the casting, we have found that not only the directional pores of the directionally or partially directionally solidified castings but also those of non- or semidirectionally solidified castings are typically amenable to absorbing many infiltrates by capillary action; infiltration with these infiltrates may be accomplished by placing an end in the melted infiltrate, and/or by fully immersing it in the infiltrate. In some alternative embodiments, vacuum-assisted or pressure assisted infiltration is used to expedite infiltration and permit infiltration with higher viscosity infiltrates such as whipped cream, jellies or white, milk and dark chocolate.

In some embodiments, an optional glaze or candy coating, such as a melted dark, milk or white chocolate coating, is then applied 314 and cooled as known in the confectioner's art.

In an alternative embodiment, instead of infiltrating the casting, the lyophilized casting is chopped or crushed 320 to form a crunchy particulate candy additive. This is added to a non-aqueous candy such as a melted chocolate that is then allowed to cool.

In an alternative embodiment, an infiltrated casting, or cut portions thereof, are included as a solid portion in a candy.

In alternative embodiments, non-infiltrated castings or cut portions thereof are included as solid portions in a candy.

### Prototype Preparation

In making prototypes, sugar solutions and sugar-solution/cocoa powder suspensions were prepared as 10 mL samples in 50 mL plastic cups or as 30 mL samples in glass ware. First, the respective sugar was weighed with a precision balance to within 1% accuracy. Maple sap, maple syrup and sugar solution concentrations of 5-20 vol. % were prepared. Note that some test castings were made from maple sap that had been raised in sugar concentration from the natural 2-3% to 8% by reverse osmosis. Solutions of different sugars were mixed, where appropriate, and any additional ingredients, such as cocoa powder, milk powder, almond powder, sweetened condensed milk or a combination of such substances, were added to the slurry according to the recipe, for recipes experimented with please see tables 1-8 below. Alcohol, if called for by a particular recipe, may be added. We believe that any ethyl alcohol used as a pore-size modifier is fully sublimated during the freeze-drying process, and thus does not remain in the final casting. The solution or slurry is finally thoroughly mixed before freezing. Some prototypes were hand mixed, others still were whipped into a foam before freezing.

The samples were typically prepared with a cooling rate of either 1° C./min or 10° C./min applied to the cold plate (bottom plate of the mold). In a particular embodiment, each mold has a tubular shape with an inner diameter of 18.8 mm (¾ inch) and a height of 40 mm.

A few sample castings (as listed in Table 2) were made using chocolate instead of cocoa powder, and successfully infiltrated with cocoa butter.

A few castings (as listed in Table 4, 5, and 8) having high solid content and having longer-chain carbohydrates as binder were successfully infiltrated with a commercial blackberry jelly diluted with water. While such an infiltrate would disrupt a simple monosaccharide or disaccharide casting, it is believed that the high solid content and long chains reduces casting solubility enough that the casting remains stable long enough to absorb the infiltrate.

### Results

Certain recipes resulted in freeze-cast and lyophilized materials having sufficient mechanical stability to undergo post-lyophilization infiltration. Recipes tested and results obtained are given in tables 1-8. In the tables, a Y in an infiltration column indicates successful infiltration of a casting with cocoa butter. A blank, UT, or Untested indicates an untested combination, a Y in a recipe column indicates successful production of a freeze-dried casting, where an X indicates casting failed or collapsed, and an O indicates a casting with problems such as excessive stickiness, highly irregular pore structure or partial collapse.

Ingredients used for experiments, and their sources, include:

100% Cocoa Butter; Venchi S.p.A. Via Venchi, 1-12040 Castelletto Stura (Cuneo), Piemonte, Italy

“Certo”, Premium Liquid Fruit Pectin; Ingredients: Water, Fruit Pectin, Lactic Acid and Citric Acid, Potassium Citrate, Sodium Benzoate; Kraft Foods Global, Inc., Northfield, Ill. 60093-2753, USA

Blackberry Jelly, Bonne Maman®; Ingredients: Blackberry Juice, Sugar, Cane Sugar, Concentrated Lemon Juice, Fruit Pectin; Andros Foods, F-46130 Biars, France

Maple Sap, Concentrated Maple Sap, Maple Syrup, Maples Sugar; Mt. Cube Sugar Farm, 1363 NH-25A, Orford, N.H. 03777, USA.

Justin's Chocolate Hazelnut Butter Blend; Ingredients: Dry Roasted Hazelnuts, Dry Roasted Almonds, Organic Cane Sugar, Organic Cocoa, Organic Cocoa Butter, Palm Fruit Oil*, Vanilla, Sea Salt; Justin's, 736 Pearl Street, Boulder, Colo. 80302, USA

Dr. Oetker, Instant Mousse Mix, Dark Chocolate Truffle Flavor; Dr. Oetker USA LLC, 10,000 Midlantic Drive Suite 107W, Mount Laurel, N.J. 08054, USA

Grated Sushi Wasabi. AFC Franchise Corp., 19205 S. Laurel Park Rd, Rancho Dominguez, Calif. 90220, USA

Sweetened Condensed Milk, Eagle Brand®. The J.M. Smucker Company, 1 Strawberry Lane, Orrville, Ohio 44667-0280, USA

Mott's® Natural Applesauce, Mott's LLP, Plano, Tex. 75086-9077, USA

Mott's® Original Applesauce, Mott's LLP, Plano, Tex. 75086-9077, USA

Cocoa Rouge Unsweetened Cocoa Powder; Guittard Chocolate Company, 10 Guittard Road, Burlingame, Calif. 94010, USA

Citrucel; GlaxoSmithKline, Consumer Healthcare, L.P., Moon Township, PA 15108, USA

Woodstock Organic Tomato Ketchup; Woodstock, 313 Iron Horse Way, Providence, R.I. 02908, USA

Heinz Tomato Ketchup; H.J. Heinz Co., L.P., Pittsburgh, Pa. 15222, USA

Nestle Carnation® Instant Nonfat Dry Milk, fortified with Vitamins A+D; Nestlé Baking, Nestlé USA, Inc, Solon, Ohio 44139 USA

King Arthur Flour, Almond Flour, Super Finely Ground & Gluten Free; The King Arthur Flour Company, Inc., Norwich, Vt. 05055, USA

Pomegranate Juice, R. W. Knudsen Pomegranate Juice Concentrate; Knudsen & Sons, Inc., Chico, Calif. 95927, USA.

For many of the sugars tried, it was found that there is a maximum percentage beyond which casting formation fails because of excessive stickiness and retained moisture during freeze-drying; better results are often obtained by diluting the material, or adding finely ground vegetable matter, prior to freeze-casting. For corn syrup used alone the sugar percentage should not exceed 40%, and invert sugar or maple sugar should not exceed 20%.

| | Sugar | Carbohydrate | Cocoa Powder | | | | | Infiltration |
|---|---|---|---|---|---|---|---|---|
| | Content of | stock | Content, | | | | | Successful |
| | Carbohydrate | Concentration | percent by volume | | | | | with |
| Carbohydrate | Stock | in Solution | 0 | 5 | 10 | 30 | 50 | Cocoa Butter |
| Maple Sap | ~3% | 100% | Y | UT | UT | UT | UT | UT |
| Maple Sap | ~8% | 10% | Y | UT | Y | UT | UT | Y |
| Maple Sap | ~8% | 100% | Y | UT | UT | UT | UT | Y |
| Maple | >66.9% | 10% | Y | UT | O | Y | Y | Y |
| Syrup | | | | | | | | |
| Maple | >66.9% | 15% | O | UT | O | Y | Y | UT |
| Syrup | | | | | | | | |
| Maple | >66.9% | 20% | O | UT | O | Y | Y | UT |
| Syrup | | | | | | | | |
| Invert | 100% | 5% | X | UT | UT | UT | UT | UT |
| Sugar | | | | | | | | |
| Invert | 100% | 10% | X | UT | O | Y | Y | UT |
| Sugar | | | | | | | | |
| Invert | 100% | 15% | O | UT | O | UT | UT | UT |
| Sugar | | | | | | | | |
| Invert | 100% | 20% | O | UT | UT | UT | UT | UT |
| Sugar | | | | | | | | |
| Glucose | 100% | 5% | UT | Y | | | | UT |
| Glucose | 100% | 10% | O | UT | | | | UT |
| Sucrose | 100% | 5% | UT | Y | | | | Y |
| Sucrose | 100% | 10% | Y | UT | | | | Y |
| Trehalose | 100% | 5% | UT | Y | | | | Y |
| Trehalose | 100% | 10% | Y | UT | | | | Y |
| Sucrose- | 100% | 5% | UT | Y | | | | Y |
| Trehalose | | | | | | | | |
| (50:50) | | | | | | | | |
| Sucrose- | 100% | 10% | Y | UT | | | | Y |
| Trehalose | | | | | | | | |
| (50:50) | | | | | | | | |

Table 1, Experimental recipes and results with sugars as carbohydrate phase, proportions in volume percentages.

TABLE 2
Blends of molten chocolate with added Sugars or Fruit Juice,
Compositions in weight percentage.

| | Sugar | | Molten Chocolate (Cocoa | | | | Successful |
|---|---|---|---|---|---|---|---|
| | Content | Carbohydrate | Content/Type) | | | | Infiltration |
| | of | stock | (S = Semisweet, W = White) | | | | with |
| | Carbohydrate | Concentration | 50% | 57% | 20% | 17% | Cocoa |
| Carbohydrate | Stock | in Solution | (100%) | (60%) | (S) | (W) | Butter |
| Maple Sap | ~3% | 50% | Y | UT | UT | UT | Y |
| Maple Sap | ~8% | 50% | UT | UT | Y | UT | Y |
| Maple Syrup | >66.9% | 50% | UT | UT | UT | Y | Y |
| Pomegranate | 15% | 43% | UT | O | UT | UT | Y |
| Juice | | | | | | | |
| Concentrate | | | | | | | |
| (R.W. Knudsen) | | | | | | | |

| | Carbohydrate | | |
|---|---|---|---|
| | Concentration | | |
| | in Solution | | |
| Carbohydrate | 1.2% | 2.4% | 4.8% |
| Agar | Y | Y | Y |
| Agarose | Y | Y | Y |
| Alginate | Y | Y | Y |
| Alginate-Chitosan Blend | Y | Y | Y |
| Carboxymethyl Cellulose (CMC) | Y | Y | Y |
| Chitosan | Y | Y | Y |
| Gelatin | Y | Y | Y |
| Nanofibrillated Cellulose (NFC) | Y | Y | Y |

Table 3, binders that can also be used alone to make castings

| | | | | | | Successful |
|---|---|---|---|---|---|---|
| | | | | | | Infiltration |
| | | | | | | with |
| | | | | | | Blackberry |
| | Sugar | | | | | Jelly |
| | Content of | | | | Successful | (Bonne |
| | Carbohydrate | | | | Infiltration | Maman ®) |
| | as provided | | | | with | (15 ml Jelly + |
| | on Package | Water Added | | | Cocoa | 5 ml |
| Carbohydrate | (wt. %) | 0% | 50% | 75% | Butter | Water) |
| Apple Sauce | 10% | Y | Y | Untested | Y | Y |
| (Mott's Original) | | | | | (0%, 50% | (0%, 50% |
| | | | | | Water | Water |
| | | | | | Added) | Added) |
| Apple Sauce | 20% | Y | Y | Untested | Y | Y |
| (Mott's Natural) | | | | | (0%, 50% | (0%, 50% |
| | | | | | Water | Water |
| | | | | | Added) | Added) |
| Sweetened | 56% | X | O | Y | Y | Y |
| Condensed Milk | | | | | (75% | (75% |
| (Eagle Brand) | | | | | Water | Water |
| | | | | | Added) | Added) |
| Blackberry Jelly | 65% | X | X | Y | Y | N/A |
| (Bonne Maman ®) | | | | | (75% | |
| Gelling Agent: | | | | | Water | |
| Pectin | | | | | Added) | |

Table 4, additional combinations tested for casting production and infiltration.

| | | | | | Successful |
|---|---|---|---|---|---|
| | | | | | Infiltration |
| | | | | | with |
| | Sugar Content | 0% by | 50% by | | Blackberry |
| | of | volume | volume | Successful | Jelly ® |
| | Carbohydrate | water | water | Infiltration | (Bonne |
| | as provided | added to | added to | with | Maman) (15 ml |
| | on Package | stock | stock | Cocoa | Jelly + |
| Carbohydrate | (wt. %) | solution | solution | Butter | 5 ml Water) |
| Citrucel | N/A | Y | UT | Y | Y |
| (GlaxoSmithKline) | (Maltodextrin, | | | | |
| Gelling Agent | Sucrose) | | | | |
| Methylcellulose: 0.8% | | | | | |
| (Heaped Tablespoon in | | | | | |
| 250 ml water) | | | | | |
| Grated Sushi Wasabi | 20% | Untested | Y | Y | Y |
| (AFC) | (Sorbitol) | | | | |
| Gelling Agent: Xanthan | | | | | |
| Gum | | | | | |
| Organic Tomato | 27% | Y | Y | Y | Y |
| Ketchup | (Organic | | | | |
| (Woodstock) | Sucrose) | | | | |
| Tomato Ketchup | 27% | Y | UT | Y | Y |
| (Heinz) | (High | | | | |
| | Fructose Corn | | | | |
| | Syrup, Corn | | | | |
| | Syrup) | | | | |
| 100% Cocoa Butter | 0% | Untested | Y | Y | Tri-layer |
| (Venchi) | | | | Tri-layer | formed: |
| | | | | formed: | cocoa butter, |
| | | | | cocoa | cocoa butter |
| | | | | butter, | Citrucel |
| | | | | cocoa butter | composite, |
| | | | | Citrucel | Jelly- |
| | | | | composite, | infiltrated |
| | | | | Citrucel | Citrucel |
| | | | | foam | foam Y |

Table 5, additional recipes

| Citrucel 0.8% wt. | | | | | Successful |
|---|---|---|---|---|---|
| Methylcellulose | Nominal Sugar | 0% | 50% | 15 ml | Infiltration |
| (GlaxoSmithKline) > | Content on | Cocoa | | Stock | with |
| Binder Content | Package (wt. %) | powder | | solution | Cocoa Butter |
| Organic Tomato Ketchup | 27% | Y | Y | UT | Y |
| (Woodstock) | (Organic | | | | |
| | Sucrose) | | | | |
| Tomato Ketchup | 27% | Y | UT | UT | Y |
| (Heinz) | (High Fructose | | | | |
| | Corn Syrup, Corn | | | | |
| | Syrup) | | | | |
| 100% Cocoa Butter | 0% | UT | Y | UT | Y, Multilayer |
| (Venchi) | | | | | system formed |
| 10 g of 100% Milk Powder | 52% | UT | UT | Y | Y |
| (Nestle) | | | | | |
| plus 15 ml of Citrucel | | | | | |
| then filled to 30 ml with | | | | | |
| water | | | | | |
| 10 g of 100% Almond | 4% | UT | UT | Y | Y |
| Powder (King Arthur Flour) | | | | | |
| plus 15 ml of Citrucel | | | | | |
| then filled to 30 ml with | | | | | |
| water | | | | | |

Table 6, Complex Carbohydrate (methyl cellulose) casting results, compositions by volume.

| | Cocoa Powder Content | | | |
|---|---|---|---|---|
| | | | | Successful |
| | Nominal | 8 g | 10 g | Infiltration |
| | Sugar | Cocoa | Cocoa | with |
| Binder Content | Content | Powder | Powder | Cocoa Butter |
| 50% Blackberry Jelly | 32.5% | Y | Y | Y |
| (Bonne Maman ®) | (Sucrose) | | | |
| Gelling Agent: Pectin | | | | |
| 50% Water | | | | |
| 50% Sweetened Condensed | 44% | UT | Y | Y |
| Milk (Eagle Brand) | (Sucrose) | | | |
| 25% Blackberry Jelly | | | | |
| (Bonne Maman ®) | | | | |
| Gelling Agent: Pectin | | | | |
| 25% Water | | | | |

Table 7, compositions in weight percent. Jellies and jams with added cocoa powder. Weighed amount of cocoa powder filled to 30 ml with diluted jelly mix.

| | 100% Almond Powder | | | |
|---|---|---|---|---|
| | | 10 ml | | Successful |
| | | almond powder | Successful | Infiltration |
| | Nominal | filled to | Infiltration | with 75% |
| | Sugar | 30 ml with | with | blackberry |
| Binder Content | Content | diluted jelly | Cocoa Butter | jelly |
| 15 ml of: | ~16.25% | Y | Y | Y |
| 50% Blackberry | (Sucrose) | | | |
| Jelly | | | | |
| (Bonne | | | | |
| Maman ®) | | | | |
| Gelling Agent: | | | | |
| Pectin | | | | |
| 50% Water | | | | |
| then filled with | | | | |
| water to 30 ml | | | | |

Table 8, almond powder compositions

### Porosity

The porosity of the freeze-dried material is determined in quantity, size and shape by the concentrations of sugar solutions and type and amounts of freeze-modifier additives, such as including the alcohol content of the slurry. Pore sizes may also be adjusted by altering the rate of freezing during the freeze-casting step of the process. Similarly, the pore aspect ratio depends on the solution/slurry composition and processing parameter such as the cooling rate and the temperature gradient along the mold during freezing or freeze casting.

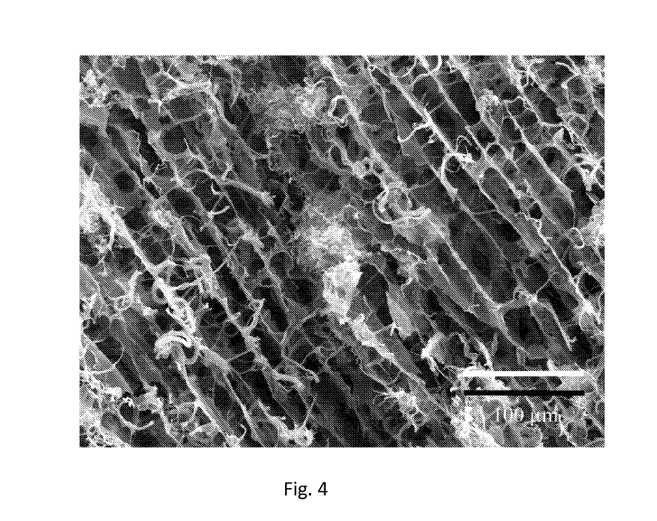

In one series of experiments, pores averaged about 900 square microns in cross section. Pores are enlarged along the axis of freezing with most pores having lengths over 10,000 microns, and many pores extend through the entire 35 mm of an experimental casting, as illustrated in FIG. 4. Other embodiments gave average pore sizes ranging from 1500 to 2000 square microns, with pore aspect ratios ranging from 1.4 to 4.5 and porosity of as much as 97 percent, sometimes more. It is expected that pore sizes and overall porosity may be adjusted by altering concentrations of solids in the solution/slurry, the rate of freezing during the freeze-casting step of the process, as well as freeze modifiers like the ethanol content of the slurry, pore size gradients or variations along the length of the sample may further be controlled and adjusted by altering recipes, applied cooling rate or applying thermal property variations along the freeze-casting mold during the freezing process. Some embodiments are expected to have average pore sizes of 900 to 3000 square microns.

Property gradients can be introduced in composition, adding solutions or slurries one after one another in the direction of freezing, with or without time for interdiffusion between the layers, by creating core-shell structures through successive freezing of first a shell and then a core, for example (either within a frozen or an already lyophilized shell, for example, or by changing the cooling rate during the freezing process or any combinations of these.

Combinations;

It is believed that any of the low-moisture infiltrates described herein, including melted dark, milk, or white chocolate, cocoa butter, palm oil and coconut oil, with or without added flavorings, are applicable to use with any casting recipe herein that produced a stable casting. It is also believed that higher-moisture infiltrates, such as diluted and flavored jellies, are adaptable to use with castings produced from recipes described herein that include long-chain carbohydrates such as methyl cellulose, nanocellulose, or pectin. While we have tested diluted applesauce—a puree of cooked apples—as a binder in both natural and sugar-added forms, we believe that castings can be achieved with many other fruit purees. Similarly, while one fruit juice was tested, we believe the method applicable to many other fruit juices and fruit juice combinations. Among specific combinations we believe functional are:

A method of manufacture designated A of an edible product including: preparing an aqueous solution or slurry containing at least one edible carbohydrate; freezing the solution or slurry with directional crystal growth by applying low temperatures with a temperature gradient to the solution or slurry to prepare frozen slurry; and lyophilizing the frozen slurry to prepare a casting.

A method designated AA including the method designated A wherein the solution or slurry includes fruit puree.

A method designated AB including the method designated AA wherein the fruit puree includes apple puree.

A method designated AC including the method designated A, AA, or AB wherein the solution or slurry includes fruit juice or fruit juice concentrates.

A method designated AD including the method designated AC wherein the fruit juice or fruit juice concentrates includes blackberry or pomegranate juice.

A method designated AE including the method designated A, AA, AB, AC, or AD wherein the solution or slurry includes at least one carbohydrate selected from the group consisting of monosaccharides and disaccharides.

A method designated AF including the method designated A, AA, AB, AC, AD, or AE wherein the solution or slurry includes finely ground vegetable matter.

A method designated AG including the method designated AF wherein the finely ground vegetable matter includes cocoa powder.

A method designated AH including the method designated AF or AF wherein the finely ground vegetable matter includes walnut, pecan nut, peanut, almond, hazelnut or coconut powder.

A method designated AJ including the method designated A, AA, AB, AC, AD, AE, AF, AG, or AH further including infiltrating the casting with an infiltrate comprising at least one fat selected from the group consisting of melted chocolate, cocoa butter, butter, palm oil, or cream.

A method designated AJA including the method designated AJ wherein the infiltrate comprises cocoa butter.

A method designated AK including the method designated A, AA, AB, AC, AD, AE, AF, AG, or AH wherein the slurry includes a long-chain carbohydrate and further including infiltrating the casting with an infiltrate comprising a jelly.

A method designated AL including the method designated A, AA, AB, AC, AD, AE, AF, AG, AH, AJ, or AK, further including applying a candy coating to the infiltrated casting.

An edible composition of matter designated B including a directionally-porous mass comprising at least one carbohydrate; a low-moisture infiltrate disposed within pores of the directionally-porous mass comprising at least one fat selected from the group consisting of melted chocolate, butter, cocoa butter, butter, palm oil, or cream.

An edible composition of matter designated BA including the composition designated B wherein the directionally-porous mass comprises desiccated components from fruit puree or fruit juice.

An edible composition of matter designated BAA including the composition designated BA wherein the fruit puree or fruit juice is selected from apple, blackberry, or pomegranate.

An edible composition of matter designated BB including the composition designated B, BA, or BAA wherein the directionally porous mass incorporates finely ground vegetable matter.

An edible composition of matter designated BBA including the composition designated BB wherein the finely ground vegetable matter comprises cocoa powder.

An edible composition of matter designated BC including the composition designated B, BA, BAA, BB, or BBA further including a candy coating.

### CONCLUSION

The experiments herein described provide indications of a new way to make edible candies having texture and flavor combinations previously unknown in the art. In particular, we expect the intricate combination of porous, desiccated, aqueous phases containing carbohydrates, optional fruit purees, and potentially high percentages of cocoa, with pores infiltrated with non-aqueous and low-to-medium moisture phases such as melted dark, milk, or white chocolate or cocoa butter, to be of attractive and potentially novel textures and flavors.

While the embodiments have been particularly shown and described with reference to particular embodiments thereof, it will be understood by those skilled in the art that various other changes in the form and details may be made without departing from the spirit and scope of the invention. It is to be understood that various changes may be made in adapting the invention to different embodiments without departing from the broader inventive concepts disclosed herein and comprehended by the claims that follow.

1. A method of manufacture of an edible product comprising:
preparing an aqueous solution or slurry comprising at least one edible carbohydrate; freezing the solution or slurry with directional crystal growth by applying low temperatures with a temperature gradient to the solution or slurry to prepare frozen slurry; and lyophilizing the frozen slurry to prepare a casting; wherein the solution or slurry comprises at least one carbohydrate selected from the group consisting of monosaccharides and disaccharides.

2. The method of claim 1 wherein the solution or slurry comprises fruit puree.

3. The method of claim 2 wherein the fruit puree comprises apple puree.

4. The method of claim 1 wherein the solution or slurry comprises fruit juice or fruit juice concentrates.

5. The method of claim 4 wherein the fruit juice or fruit juice concentrates comprises blackberry or pomegranate juice.

6. (canceled)

7. The method of claim 1 wherein the solution or slurry comprises finely ground vegetable matter.

8. The method of claim 7 wherein the finely ground vegetable matter comprises cocoa powder.

9. The method of claim 7 wherein the finely ground vegetable matter comprises walnut, pecan nut, peanut, almond, hazelnut or coconut powder.

10. The method of claim 2, further comprising:
infiltrating the casting with an infiltrate comprising at least one fat selected from the group consisting of melted chocolate, cocoa butter, butter, palm oil, coconut oil, or cream.

11. The method of claim 8, further comprising:
infiltrating the casting with an infiltrate comprising a jelly.

12. The method of claim 10 further comprising:
applying a candy coating to the infiltrated casting.

13. The method of claim 10 wherein the infiltrate comprises cocoa butter.

14. An edible composition of matter comprising:
a directionally-porous mass comprising at least one carbohydrate, the at least one carbohydrate comprising mono- and di-saccharides;
a low-moisture infiltrate disposed within pores of the directionally-porous mass comprising at least one fat selected from the group consisting of melted chocolate, butter, cocoa butter, butter, palm oil, or cream.

15. The edible composition of claim 14 wherein the directionally-porous mass comprises desiccated components from fruit puree or fruit juice.

16. The edible composition of claim 15 wherein the fruit puree or fruit juice is selected from apple, blackberry, or pomegranate.

17. The edible composition of claim 14, wherein the directionally porous mass incorporates finely ground vegetable matter.

18. The edible composition of claim 17 wherein the finely ground vegetable matter comprises cocoa powder.

19. The edible composition of claim 18 further comprising a candy coating.

20. A method of manufacture of an edible product comprising:
preparing an aqueous solution or slurry comprising at least one edible carbohydrate and chocolate; freezing the solution or slurry with directional crystal growth by applying low temperatures with a temperature gradient to the solution or slurry to prepare frozen slurry; lyophilizing the frozen slurry to prepare a casting; and infiltrating the casting with an infiltrate.

21. The method of claim 20 wherein the infiltrate comprises cocoa butter.

22. The method of claim 20 wherein the infiltrate comprises jelly.
